(19) United States
(12) Patent Application Publication
(10) Pub. No.: US 2006/0282333 A1
(43) Pub. Date: Dec. 14, 2006

(54) Electronic search method for telecommunication network

(76) Inventor: Wang Yongnian, Nanjing City (CN)

Correspondence Address: Raymond Y. Chan, 108 N. Ynez Ave., #128, Monterey Park, CA, 91754, US

(21) Appl. No.: 11/150,529

(22) Filed: Jun. 9, 2005

(51) Int. Cl. G06Q 30/00

(52) U.S. Cl. 705/26

(57) ABSTRACT

A method of searching business information through a telecommunication network includes the steps of (a) providing an information center having a business information database which stores a plurality of vendor accounts; (b) receiving a search request from a user's portable communication device, wherein the search request is analyzed to generate a vendor request corresponding to the vendor accounts in the business information database; (c) sending the vendor request containing the search request from the information center to the corresponding vendor accounts; (d) receiving a plurality of feedbacks from the corresponding vendor accounts to the information center regarding to the vendor request; and (e) replying the feedbacks from the information center to the user's portable communication device in form of messages.

### BACKGROUND OF THE PRESENT INVENTION

1. Field of Invention

The present invention relates to a search method, as more particularly to an electronic search method for a telecommunication network, wherein a user is able to submit search requests and receive selected messages of relevant business information, such as vendor's response for an order request, by a mobile communication device.

2. Description of Related Arts

With the advance of information technology, it is now perfectly feasible that business decisions to be made when one is traveling around. For example, a Chief Executive Officer of a company may hook up his/her laptop to Internet for transmitting his/her instructions or decisions back to the headquarter so as to make prompt response to rapidly-changing business events.

On the other hand, a traveler wishing to stay in a particular town or city may need to know the availability of any vacant rooms at that town or city. Obviously, one way of doing that is to call the relevant hotels and reserve his/her room. The problem here is that the traveler may not even know the hotels in that city, not to mentioning their phone numbers. As a result, he may wish to access to Internet and browse the relevant information.

A common disadvantage with these examples is the availability of Internet connection when one is traveling around. If the traveler does not subscribe any wireless internet connection service, he/she may need to find a place which allows him/her to access to Internet. One might conceive however, that the availability of such a place cannot be guaranteed.

Another disadvantage is that it may not be convenient for a traveler to take his/her laptop with him/her. This is particularly so where a traveler has already had a heavy backpack or suitcase so that it is extremely difficult, if not impossible, to carry an extra laptop with him/her.

In addition, even though the traveler is somehow able to secure an Internet connection, the traditional search engine which is designed to perform extensive search may not be suitable for the traveler in that he/she may only want to obtain a filtered or limited categories of search results. For example, the traveler may only want to obtain a list of hotels in a particular geographical location, but a typical Internet search may result in a huge numbers of hotels which are undesirable to the traveler.

More specifically in business context, when a buyer seeks to inquire the prices of a particular kind of products among a range of shortlisted vendors, he/she may only need to know the prices offered by those particular shortlisted vendors. Again, a typical Internet search may return a search result which contains information of other unrelated vendors.

On the other hand, there exist another conventional business practice that when a buyer requests information from vendors through a search engine (whether through indoors Internet connection or outdoors Internet connection), those vendors who receive the buyer's request would individually send their offers to the buyer. Then, if there are large numbers of vendors who respond to the buyer's request, he/she would receive a corresponding huge amount of separate replies. This is obviously undesirable. In worse situations, some vendors may transfer the buyer's request to other companies which may then send a junk message to the buyer so that he/she may receive an even larger number of replies, and many of them are junk.

### SUMMARY OF THE PRESENT INVENTION

A main object of the present invention is to provide a method of searching business information through a telecommunication network, wherein a user is able to submit search requests and receive selected messages of relevant business information, such as vendor's response for an order request, by a mobile communication device, such as a cellular phone.

Another object of the present invention is to provide a method of searching business information through a telecommunication network, wherein a business information center is adapted for filtering reply messages from corresponding vendor accounts so as to provide a user of the present invention with optimal vendor's replies. In other words, the present invention minimizes unwanted search results as appear in conventional internet searching, so as to specifically cater for mobile telecommunication utilization.

Another object of the present invention is to provide a method of searching business information through a telecommunication network, which is adapted to be implemented on a wide variety of mobile telecommunication networks, such as cellular phones, Personal Digital Assistant (PDA), and the likes.

Another object of the present invention is to provide a method of searching business information through a telecommunication network, wherein the method is easy to use, and provide search results in the form of user-friendly and readable messages so that it is optimally tailored for mobile use.

Accordingly, in order to accomplish the above objects, the present invention provides a method of searching business information through a telecommunication network, comprising the steps of:

(a) providing an information center having a business information database which stores a plurality of vendor accounts;

(b) receiving a search request from a user's portable communication device, wherein the search request is analyzed to generate a vendor request corresponding to the vendor accounts in the business information database;

(c) sending the vendor request containing the search request from the information center to the corresponding vendor accounts;

(d) receiving a plurality of feedbacks from the corresponding vendor accounts to the information center regarding to the vendor request; and

(e) replying the feedbacks from the information center to the user's portable communication device in form of messages such that the user is able to read the feedbacks from the portable communication device for facilitating a business deal between the user and the corresponding vendor accounts.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of an electronic search system according to a preferred embodiment of the present invention.

FIG. 2 is a flow diagram of a method of searching business information through a telecommunication network according to the above preferred embodiment of the present invention.

### DETAILED DESCRIPTION OF THE PREFERRED EMBODIMENT

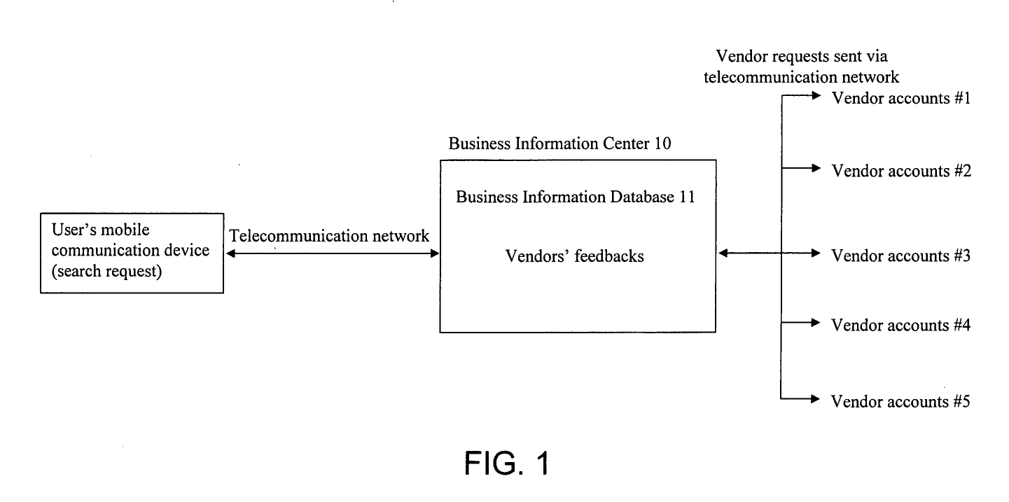

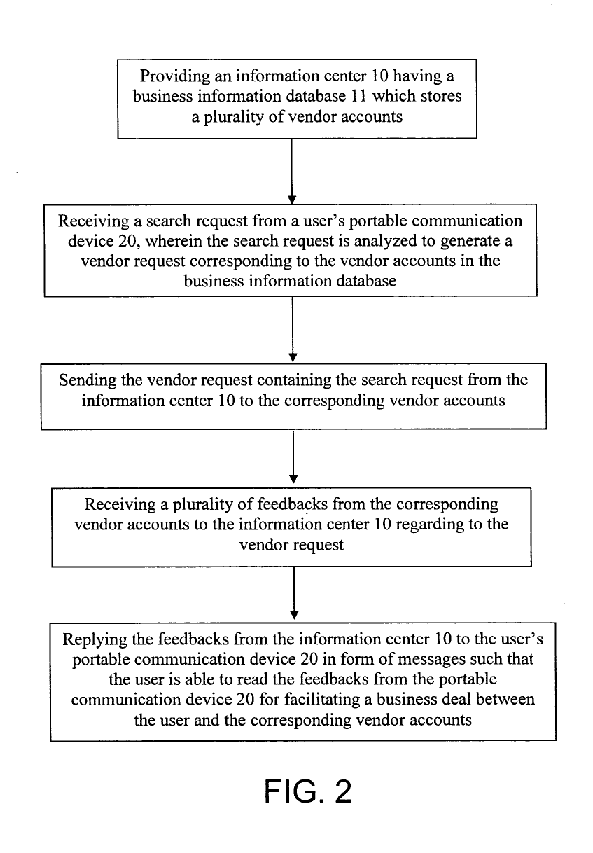

Referring to FIG. 1 to FIG. 2 of the drawings, a method of searching business information through a telecommunication network is illustrated. According to the preferred embodiment of the present invention, the method comprises the steps of:

(a) providing an information center 10 having a business information database 11 which stores a plurality of vendor accounts;

(b) receiving a search request from a user's portable communication device 20, wherein the search request is analyzed to generate a vendor request corresponding to the vendor accounts in the business information database;

(c) sending the vendor request containing the search request from the information center 10 to the corresponding vendor accounts, wherein the vendor accounts produce a plurality of feedbacks to the corresponding search request;

(d) receiving the feedbacks from the corresponding vendor accounts to the information center 10 regarding to the vendor request; and

(e) replying the feedbacks from the information center 10 to the user's portable communication device 20 in form of messages such that the user is able to read the feedbacks from the portable communication device 20 for facilitating a business deal between the user and the corresponding vendor accounts.

The portable communication device 20 is preferably embodied as conventional portable communication devices utilizing telecommunication network for transmitting information, such as cellular phone, Personal Digital Assistant (PDA), pocket computer etc. Thus, the portable communication device is adapted for conveniently carried over in outdoors environment without imposing significant burden to the user of the present invention.

The business information database 11 is open for registration by business organizations or even individuals to set up their respective vendor accounts so that the user is capable of searching the relevant vendor accounts when making the search request. In other words, step (a) comprises a step of registering the vendor accounts by a plurality of vendors for forming the business information database 11.

Accordingly, the vendor accounts are required to supply the business information database 11 with a predetermined number of attributes so as to support an optimal search by the user of the present invention. For example, the vendor accounts may be sorted by particular geographical location/area so that only those vendor accounts which are established in a particular geographical location will be sent with the search request, and therefore, reply to the user in the form of messages as mentioned in step (e). Alternatively, the vendor accounts may be sorted by the nature of their business activities such that the user may be to search a particular industry for his/her optimal use.

Thus, the search request contains at least one search attribute for identifying the need of the user so as to perform the corresponding analysis and search within the business information database 11. For instances, the search request may requires information for hotels, and the search attribute may stipulate specific requirement of the hotels which are to be search so as to narrow down the search ambit for obtaining optimal result for the user. In this case, the search ambit may be to stipulate the geographical location of the hotels, or the price range of the hotels which are desirable.

Step (b) comprises the steps of:

(b.1) identifying a search attribute of the search request; and

(b.2) matching the search request with the vendor accounts which correspond with the search attribute so as to generate the vendor request.

In step (c), the vendor request is sent to the corresponding vendor accounts by the telecommunication network preferably in the form of a short message so as to inform the corresponding vendor accounts the need of the user. According to the preferred embodiment of the present invention, the vendor request is sent to the vendor's telecommunication terminal, such as a specifically assigned cellular or fixed line phone account, a fax machine, or any other communication devices.

When the vendor request is received by the corresponding vendors, they would then process the vendor request and make the corresponding offers. For example, where the vendor request involves bookings of hotel rooms, the vendors may check availability and make the corresponding offers. The offers are then sent back to the information center 10 to form the plurality of feedbacks in step (d).

It is worth mentioning that in order to facilitate effective and efficient business dealing between the user and the vendor, the time within which the offers would be accepted to generate the feedbacks may be limited. This limitation is preferably stipulated as a search attribute contained in the search request.

Therefore, step (d) comprises the steps of:

(d.1) counting a predetermined period of time within which the feedbacks are validly received from the vendor accounts; and

(d.2) invalidating the corresponding feedbacks when the predetermined period of time elapses.

Note that when the predetermined period of time elapses, the information center will no longer validate and further process the relevant feedbacks so as to give the user of the present invention certainty as to the choices available to him/her. In other words, the user no longer need to worry, for example, after three minutes he has accepted a particular offer, a better deal occurs. Since the specified time frame is stipulated in the search request as one of the search attributes, it is expected that the majority of vendors would give effect to this search attribute. Thus, step (d.2) simply serves to block junk replies while preserving any genuine business opportunity between the relevant vendors and the user of the present invention.

Moreover, step (d.2) also serves to delimit the number of replies into a manageable framework so as to facilitate efficient use of the information center's 10 resources.

Step (e) further comprises the steps of:

(e.1) compiling the feedbacks into the plurality of messages which contain information of the corresponding vendor accounts; and

(e.2) sending the messages to the user's portable communication device so as to allow the user to make a corresponding decision from the messages.

A remarkable feature of the present invention is that the user will not receive a huge bundle of search results so as to require him to spend considerable effort into analyzing the search result before he can make any sensible decision. In contrast, the present invention enables the user to search based on a number of specifically requested search attributes (instead of a general field of category) so as to render the search result optimal. Moreover, in order to further ensure the optimality of the replies, the method of searching business information further comprises a step, in between step (d) and step (e), of verifying a relevance of the feedbacks, so as to filter irrelevant feedbacks for providing optimal search result to the user of the present invention.

Obviously, if no suitable vendor can be found in the business information database 11, the user would be informed and a new search may be performed. Thus, the method of search business information further comprises a step (f) of prompting the user when no vendor account matches with the search request. Again, the prompting may be made in the form of messages sent to the user's mobile communication device 20. The user may then repeat the search by performing step (a) through step (e) again with broadened search attributes so as to acquire the nearest possible relevant search result.

Another remarkable feature of the present invention is that the vendor accounts may be able to selectively respond to the vendor request in accordance with their own circumstances. For example, where the corresponding vendors determined that the search request cannot be fulfilled, they may simply choose not to respond to the search request. As a result, the user will not receive any feedbacks which do not fulfill his/her request.

It is also worth mentioning that the present invention is adapted to implement in a wide variety of business environments. For example, it may be implemented in the business-to-customer (b-to-c) or business-to-business (b-to-b) environments so that the user, while traveling around, whether for the purpose of business or private traveling, can be able to utilize his/her mobile telecommunication device 20 for performing the most optimal search for suiting his/her particular circumstance. (e.g. booking hotels or ordering stocks in case of sudden stock shortage)

It is worth mentioning that the present invention may even be implemented into traditional computers so that the transmission of information can also be performed by Internet, while portable communication device 20 can also be embodied as a laptop or other computing devices. In such a situation, the search requests and the vendor requests may be embodied transmitted in the forms of emails so as to accomplish electronic communication of the present invention.

Moreover, various alternatives of the present invention may also be covered. For example, the information center 10 may be provided with a plurality of customer services officers who may help to receive the search requests and perform the necessary data entry and search in the business information database 11.

Finally, the corresponding vendor account may choose to respond to the user without actually going through the information center 10. As such, the feedback mentioned in step (c) may be embodied as contacts sending from the corresponding vendor accounts to the user directly.

From the forgoing descriptions, it can be shown that the above-mentioned objects can be effective accomplished. The present invention provides a method of searching business information through a telecommunication network, wherein a user is able to submit search requests and receive selected messages of relevant business information, such as vendor's response for an order request, by the mobile communication device 20, such as a cellular phone.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of searching business information through a telecommunication network, comprising the steps of:
(a) providing an information center having a business information database which stores a plurality of vendor accounts;
(b) receiving a search request from a user's portable communication device, wherein said search request is analyzed to generate a vendor request corresponding to said vendor accounts in said business information database; and
(c) sending said vendor request containing said search request from said information center to said corresponding vendor accounts, wherein said corresponding vendor accounts produce a plurality of feedbacks corresponding to said search request.

2. The method, as recited in claim 1, further comprising the steps of:
(d) receiving said feedbacks from said corresponding vendor accounts to said information center regarding to said vendor request; and
(e) replying said feedbacks from said information center to said user's portable communication device in form of messages such that said user is able to read said feedbacks from said portable communication device for facilitating a business deal between said user and said corresponding vendor accounts.

3. The method, as recited in claim 1, wherein said step (b) comprises the steps of:
(b.1) identifying a search attribute of said search request; and
(b.2) matching said search request with said vendor accounts which correspond with said search attribute so as to generate said vendor request.

4. The method, as recited in claim 2, wherein said step (b) comprises the steps of:
(b.1) identifying a search attribute of said search request; and
(b.2) matching said search request with said vendor accounts which correspond with said search attribute so as to generate said vendor request.

5. The method, as recited in claim 4, wherein said step (e) further comprises the steps of:
(e.1) compiling said feedbacks into said messages which contain information of said corresponding vendor accounts; and
(e.2) sending said messages to said user's portable communication device so as to allow said user to make a corresponding decision from said messages.

6. The method, as recited in claim 2, wherein said step (d) comprises the steps of:
(d.1) counting a predetermined period of time within which said feedbacks are validly received from said vendor accounts; and
(d.2) invalidating said corresponding feedbacks when said predetermined period of time elapses.

7. The method, as recited in claim 5, wherein said step (d) comprises the steps of:
(d.1) counting a predetermined period of time within which said feedbacks are validly received from said vendor accounts; and
(d.2) invalidating said corresponding feedbacks when said predetermined period of time elapses.

8. The method, as recited in claim 2, further comprising a step, in between said step (d) and said step (e), of verifying a relevance of said feedbacks, so as to block irrelevant feedbacks for providing optimal messages to said user.

9. The method, as recited in claim 6, further comprising a step, in between said step (d) and said step (e), of verifying a relevance of said feedbacks, so as to block irrelevant feedbacks for providing optimal messages to said user.

10. The method, as recited in claim 7, further comprising a step, in between said step (d) and said step (e), of verifying a relevance of said feedbacks, so as to block irrelevant feedbacks for providing optimal messages to said user.

11. The method, as recited in claim 1, wherein said step (a) comprises a step of registering said vendor accounts by a plurality of vendors for forming said business information database.

12. The method, as recited in claim 8, wherein said step (a) comprises a step of registering said vendor accounts by a plurality of vendors for forming said business information database.

13. The method, as recited in claim 9, wherein said step (a) comprises a step of registering said vendor accounts by a plurality of vendors for forming said business information database.

14. The method, as recited in claim 10, wherein said step (a) comprises a step of registering said vendor accounts by a plurality of vendors for forming said business information database.

15. The method, as recited in claim 1, further comprising a step of prompting said user when no vendor account matches with said search request, wherein said user is requested to perform a new search in said step (a).

16. The method, as recited in claim 2, further comprising a step of prompting said user when no vendor account matches with said search request, wherein said user is requested to perform a new search in said step (a).

17. The method, as recited in claim 12, further comprising a step of prompting said user when no vendor account matches with said search request, wherein said user is requested to perform a new search in said step (a).

18. The method, as recited in claim 13, further comprising a step of prompting said user when no vendor account matches with said search request, wherein said user is requested to perform a new search in said step (a).

19. The method, as recited in claim 14, further comprising a step of prompting said user when no vendor account matches with said search request, wherein said user is requested to perform a new search in said step (a).

20. The method, as recited in claim 1, wherein said portable communication device is embodied as a cellular phone which is capable of being conveniently carried over in outdoors environment so as to facilitate effective mobile search.

21. The method, as recited in claim 2, wherein said portable communication device is embodied as a cellular phone which is capable of being conveniently carried over in outdoors environment so as to facilitate effective mobile search.

22. The method, as recited in claim 17, wherein said portable communication device is embodied as a cellular phone which is capable of being conveniently carried over in outdoors environment so as to facilitate effective mobile search.

23. The method, as recited in claim 18, wherein said portable communication device is embodied as a cellular phone which is capable of being conveniently carried over in outdoors environment so as to facilitate effective mobile search.

24. The method, as recited in claim 19, wherein said portable communication device is embodied as a cellular phone which is capable of being conveniently carried over in outdoors environment so as to facilitate effective mobile search.
